(19) United States
(12) Patent Application Publication
(10) Pub. No.: US 2023/0110654 A1
(43) Pub. Date: Apr. 13, 2023

(54) Axial closed-loop flux motor or generator

(71) Applicant: Zhenxiang Zhang, St. Catharines (CA)

(72) Inventor: Zhenxiang Zhang, St. Catharines (CA)

(21) Appl. No.: 17/803,666

(22) Filed: Sep. 29, 2022

Related U.S. Application Data
(60) Provisional application No. 63/254,797, filed on Oct. 12, 2021.

(51) Int. Cl. H02K 21/24; H02K 7/08; H02K 11/21

(52) U.S. Cl. CPC H02K 21/24; H02K 7/083; H02K 11/21

(57) ABSTRACT

An axial closed-loop flux electric motor or generator is a brushless AC and DC permanent magnet motor or generator, comprising a rotor having a rotor disc, permanent magnets, a shaft, and bearings; a stator having a casing and armature(s) which comprises a C-shaped core and a coil; and an electric control system. The even-numbered permanent magnets are evenly fixed or embedded in the holes of the edge of the rotor disc. Each magnet pole NS line in the hole is parallel to the shaft axis . The magnetic poles of adjacent permanent magnets are opposite. The armatures straddle the edge of the rotor disk without touching it. A single-unit motor or a single-phase AC generator comprises a stator, a rotor and an electronic control system. Coupling two or three single-unit motors can form a dual-unit motor, a triple-unit motor or a three-phase AC generator.

### FIELD OF THE INVENTION

The present invention relates to axial flux motors and generators.

### BACKGROUND OF THE INVENTION

Axial flux motors are also known as axial gap motors, pancake motors or axial flux machine. Its flux path between the rotor and the stator is oriented parallel to the shaft axis, rather than like radial gap motors. The core technical advantage of the axial flux motor is that magnetic force works on both side of the rotor and the rotor has a larger diameter size, and torque = force x radius, so it can obtain higher torque output. The axial flux motor has the technical characteristics of compact structure, flat and ultra-thin, small size, light weight and high power density.

An example is U.S. Pat. No. 6,445,105 describing an axial flux machine includes a rotatable shaft; a rotor disk coupled to the rotatable shaft; permanent magnets supported by the rotor disk; at least one stator extension positioned in parallel with the rotor disk; An electrical coil is wrapped on the iron pole of stator extension facing the permanent magnet. Another example is U.S. Pat. 5,619,087 which discloses an electric axial flow machine comprising at least two ironless disk-shaped rotors with bar-shaped permanent magnets embedded in fibre or plastic. A plurality of adjacently arranged permanent magnets form a magnetic pole. The existing axial flux motors are similar in structure, with one or two sides of the stators and a rotor disk sandwiched in the middle, or two rotors on both sides of a middle stator. In such a structure, the magnetic flux of a stator coil and the magnetic flux of a permanent magnet do not form a closed- loop flux, so in theory, it is similar to a radial flux motor, where some of the energy is lost as reactive power. Such axial motors are now mainly used in equipment with low to medium power requirements. Therefore, it is necessary to find a simpler manufacturing process to provide axial flux motors with higher torque, power, power density and efficiency.

### SUMMARY OF THE INVENTION

Axial closed-loop flux motor or generator is a new type of brushless AC and DC permanent magnet motor or AC generator. It has a rotor, a stator and a control system. The rotor comprises a rotor disk, permanent magnets, a shaft and bearings. The stator comprises some armatures,casing and fasten parts. The armature consists of a C-shaped core and a coil. The even-numbered permanent magnets are evenly fixed in the edge holes of the rotor disk. The C-shaped iron cores of the armatures straddle the edge of the rotor disk. There is a small air gap between the C-shaped core and the rotor disk. All poses of the permanent magnets can freely pass through the grooves of all C-shaped cores on the stator.

Here are the different aspects of the present invention from the conventional motor:
1. A conventional motor uses the radial magnetic force of the motor stator to drive the rotor to rotate, so one magnetic coil on a rotor can only obtain one magnetic force. In the present invention, the two poles of an permeant magnet on both sides of a rotor can obtain double magnetic force from one magnetic coil of a C-shaped core under the same electromagnetic conversion.
2. In order to drive the rotor to rotate for a conventional motor, during the rotation process, at least one set of coils in turn does not work. Which means it’s not able to make all the coils generate magnetic force to push the rotor at the same time. Therefore, the overall calculation has at least one set of coils invalid. The present invention can make all armature coils on the motor work at the same time, so the torque and power of the motor can be increased, and the power density and efficiency are also improved.
3. The stator coils of a conventional motor are wound inside the motor, so, it cannot effectively dissipate heat, which may cause the coil to burn out. In order to dissipate heat, an additional fan is usually applied on the motor shaft, or add a oil cooler. This not only increases wind resistance, increases energy consumption, reduces motor efficiency, but also increases noise. In addition, the casing itself is required to be a heat sink. Therefore, the motor is heavy. The armature coils of the present invention is installed on the outer surface of the motor, so it has better heat dissipation. Normally no fan is required. The weight of a motor with the same power can be greatly reduced.
4. The stator coils of a conventional motor is wound inside the motor, so, the winding of the coils are complicated. The inefficiency of producing motors results in high motor manufacturing costs. Maintenance is also difficult. However, the motor of the present invention adopts individual armature and a cylindrical coil, so the manufacture is very simple. The inspection, maintenance and repairing are simple as well.
5. The present invention can be retrofitted to a shaftless motor. For example, it can be used for shaftless propellers or shaftless generators.
6. The permanent magnets are evenly fixed or embedded in the holes of a flat cylindrical disk, so the smooth disk rotor has little wind resistance even at high speed rotation.
7. One embodiment of the present invention is a dual unit motor or a triple unit motor. When starting the motor, all coils of the armatures are starting windings, and after starting are running windings. This provides even torque and more power when running.
8. The excitation rotor of a motor consumes part of the electrical energy. The rotor of the present invention uses permanent magnets, so no energy is wasted on a running rotor.
9. Due to the high magnetic energy product and high coercivity of the rare earth permanent magnet, the rare earth permanent magnet motor is smaller in size, lighter in weight, and higher in efficiency. Therefore, the permanent magnet motor can significantly improve the power factor, reduce the stator current and stator resistance loss, and run without rotor copper loss and fan friction loss.

### BRIEF DESCRIPTION OF THE DRAWINGS

FIG. 1 is a front section viewed in the axial direction of the resent invention and FIG. 1 a is a side section view of the present invention.

FIG. 2 is a drawing diagram of a rotor structure of the present invention.

FIG. 3 is a drawing diagram of an armature structure of the present invention.

FIG. 4 shows the position of coils in a generator of the present invention.

FIG. 5 shows a wiring diagram of the generator coils.

FIG. 6 is a schematics of FIG. 5.

FIG. 7 and FIG. 7a are diagrams illustrating the principle of the action of the action of a generator.

FIG. 8 shows the position of the coils in a single-unit electric motor.

FIG. 9 is a diagram showing the relationship between the coil winding method and the magnetic field in a single-unit motor.

FIG. 10 is a schematics of FIG. 9.

FIG. 11 and FIG. 11a are diagrams illustrating the principle of the action of a single-unit electric motor.

FIG. 12 is a diagram of a DC control mode for the single-unit motor.

FIG. 13 a schematics of an exemplary embodiment of FIG. 12.

FIG. 14 and FIG. 14a are diagrams illustrating the principle of the action of a dual-unit electric motor.

FIG. 15 is a side section view of an exemplary dual-unit motor.

FIG. 16 is a schematics of the coils in a dual-unit motor.

FIG. 17 shows a diagram of a DC control mode for a dual-unit Motor.

FIG. 18 is a schematics of a dual-unit AC motor control mode.

FIG. 19 and FIG. 19a are diagrams illustrating the principle of the action of a triple-unit electric motor.

FIG. 20 shows a side section view of an exemplary triple-unit motor.

FIG. 21 is a schematics of a triple-unit DC motor coil wiring.

FIG. 22 is a diagram of a triple-unit DC motor control mode.

FIG. 23 is a schematics of a triple-unit AC motor three-phase AC Star connection.

FIG. 24 is a schematics of a triple-unit AC motor three-phase AC Delta connection.

FIG. 25 shows a three-phase AC waveform.

FIG. 26 is a front view of a shftless motor or generator of the present invention.

### DETAILED DESCRIPTION OF THE OF THE INVENTION

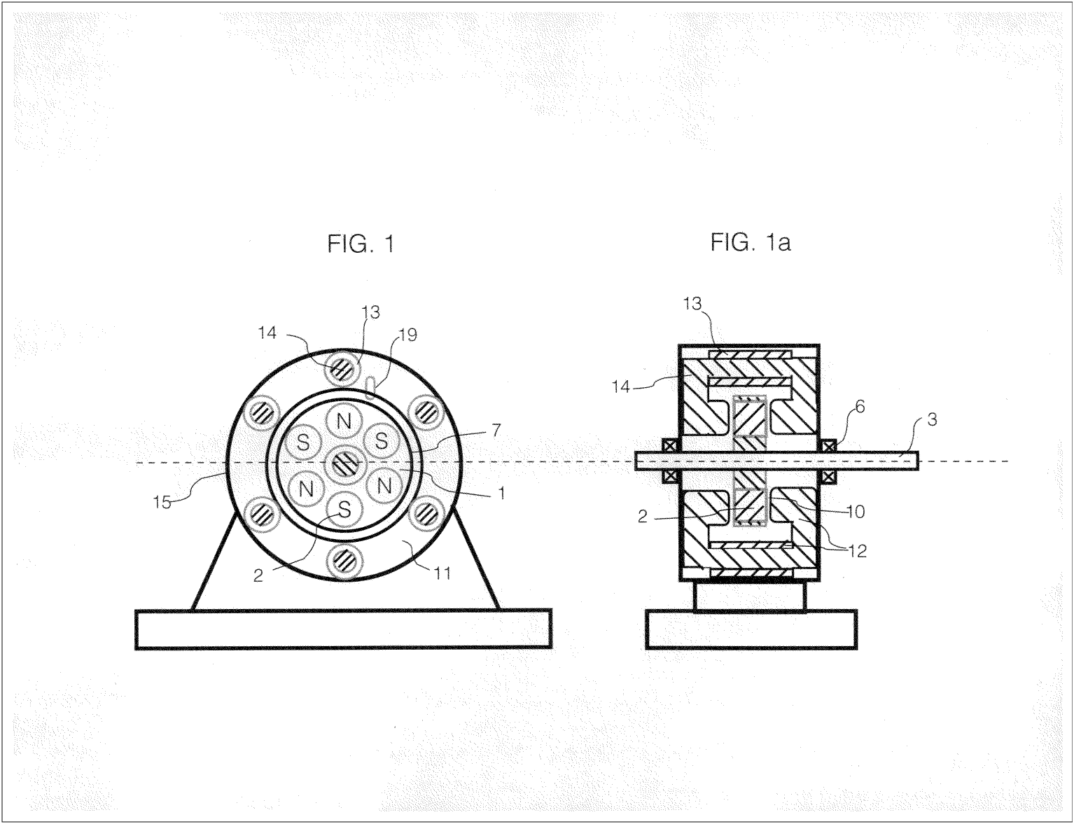

FIG. 1 is a front section viewed in the axial direction of the resent invention and FIG. 1 a is a side section view of the present invention. Illustrating a single-unit motor comprising a stator 11 , rotor 1 and an electronic control system including a rotor position sensor 19 . The stator 11 further comprises some armatures 12 and a motor casing 15 on which the armatures 12 and the bearings 6 are mounted. The armature 12 comprises a C-shaped iron core 14 and a coil 13 . Inside the stator 11 is the rotor 1 . The rotor 1 consists of a rotor disc 7 , permanent magnets 2 , a rotor shaft 3 and two bearings 6 mounted on a motor casing 15 . The C-shaped core 14 of the armature 12 straddle the edge of the rotor disc 7 without touching the disk 7 . There are air gaps 10 between the C-shaped cores 14 and the poses of the permanent magnets 2 on the rotor disc 7. The rotor 1 can freely rotate and pass through the sloovs of all C-shaped cores 14. When the rotor permanent magnet 2 passes through the gap of the C-shaped iron core 14 , the magnetic flux in the C-shaped iron core 13 overlap with the magnetic flux of the permanent magnet 2 and form a flux closed loop. A rotor position sensor 19 is installed on the stator 11, rotor 1 or shaft 3.

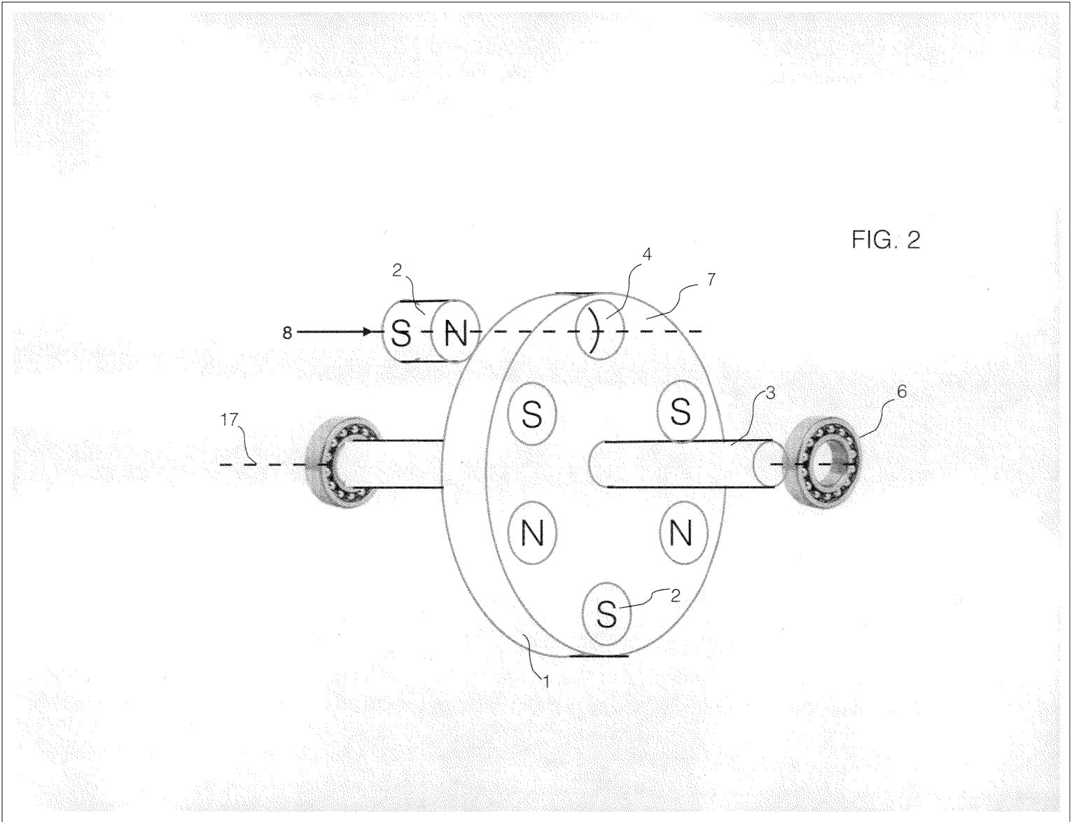

As shown in FIG. 2, Rotor1 comprises a disc 7, a shaft 3 installed in the centre of the disk 7, and two bearings 6 mounded on the shaft 3. An even number of holes 4 are distributed equidistantly from the center of the disk 7 and at equal center angles on the edge of the disk 7. Permanent magnets 2 are fixed or embedded in these holes 4. The magnetic pole NS lines 8 of the permanent magnets 2 are parallel to the shaft axis 17. The magnetic poles of adjacent permanent magnets 2 are opposite.

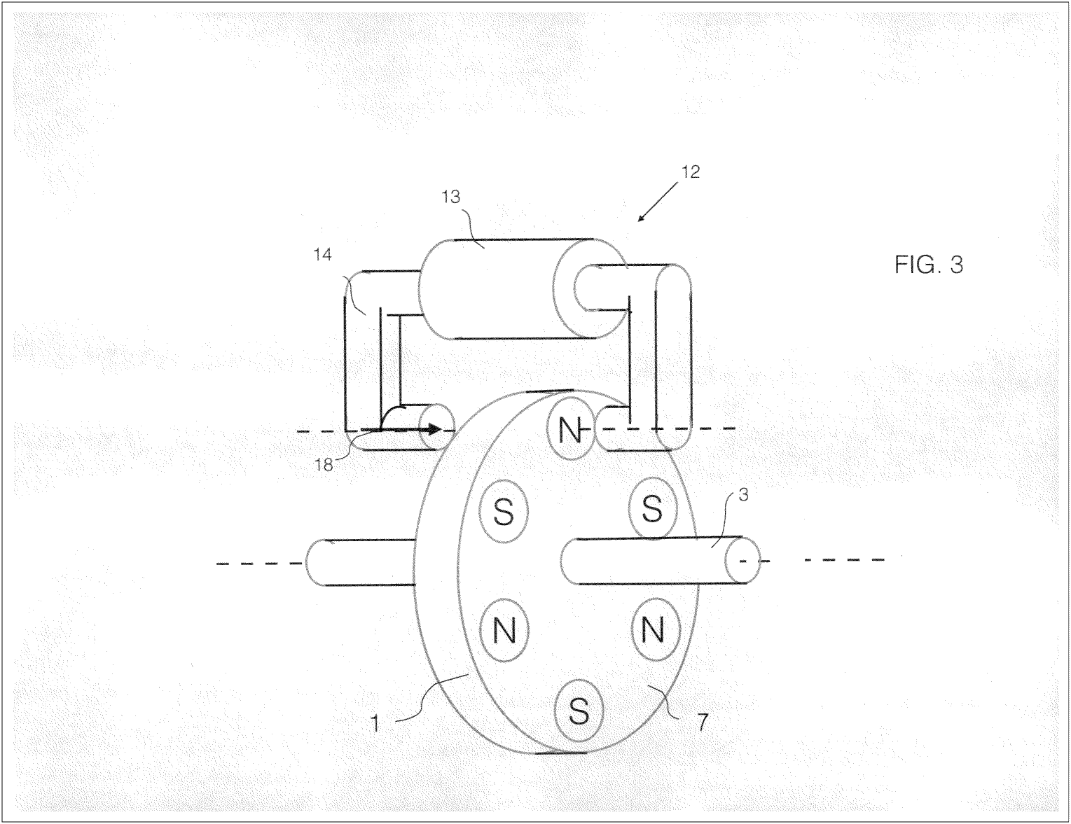

As shown in FIG. 3, A stator comprises at least one armature(s) 12 and a motor casing for fixing the armature(s) 12. The armature 12 further comprises a C-shaped core 14 and an coil 13 . The number of armatures 12 is generally equal to the number of permanent magnets 2. The specific design can be less than the number of permanent magnets 2. The armature 12 straddles the edge of the rotor disk 7 and maintains a small gap with the permanent magnets 2 on the rotor 1. When the rotor permanent magnet 2 passes through the grooves of a C-shaped iron core 14 , the magnetic flux in the C-shaped iron core overlaps with the magnetic flux of the permanent magnet 2 . The magnetic flux centerline of the C-shaped iron core on the stator preferably coincides with the magnetic flux centerline 18 of the permanent magnet 2 on the rotor 1.

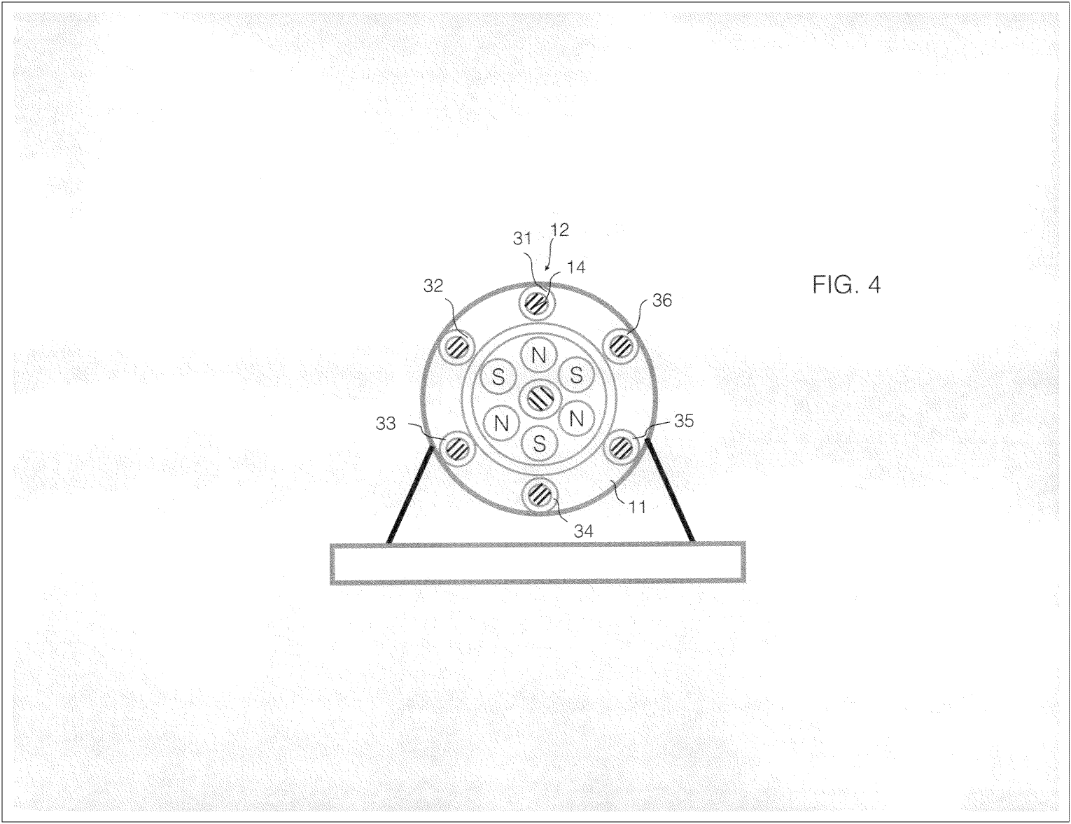

The first embodiment of the present invention is a single- unit generator. FIG. 4 is an explanatory front sectional view showing the positions of coil (1) 31, coil (2) 32, coil (3) 33, coil (4) 34, coil (5) 35 and coil (6) 36 in a stator 11.

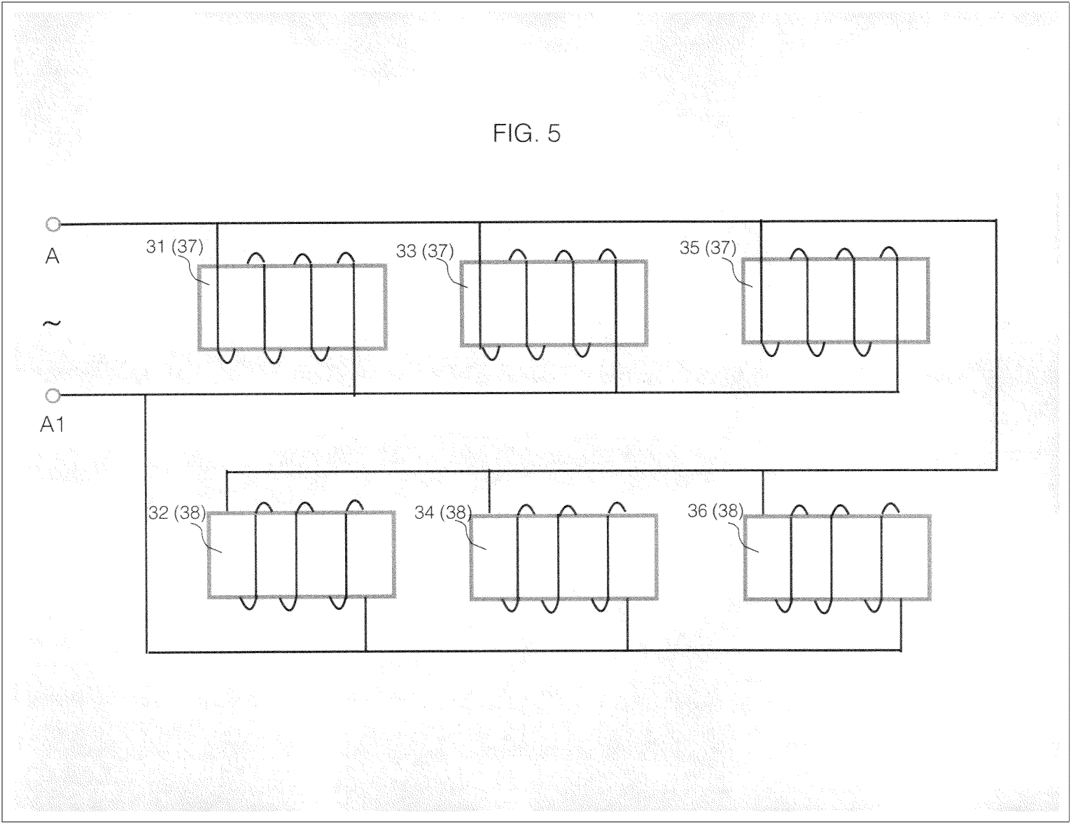

FIG. 5 is a diagram of the coils in a single- unit generator. Coil (1) 31 , coil (3) 33 and coil ( 5) 35 are right-handed coils 37 , and coil (2) 32 , coil (4) 34 and coil (6) 36 are left-handed coils 38 . All coils are connected in parallel, and the connection ports are A and A1.

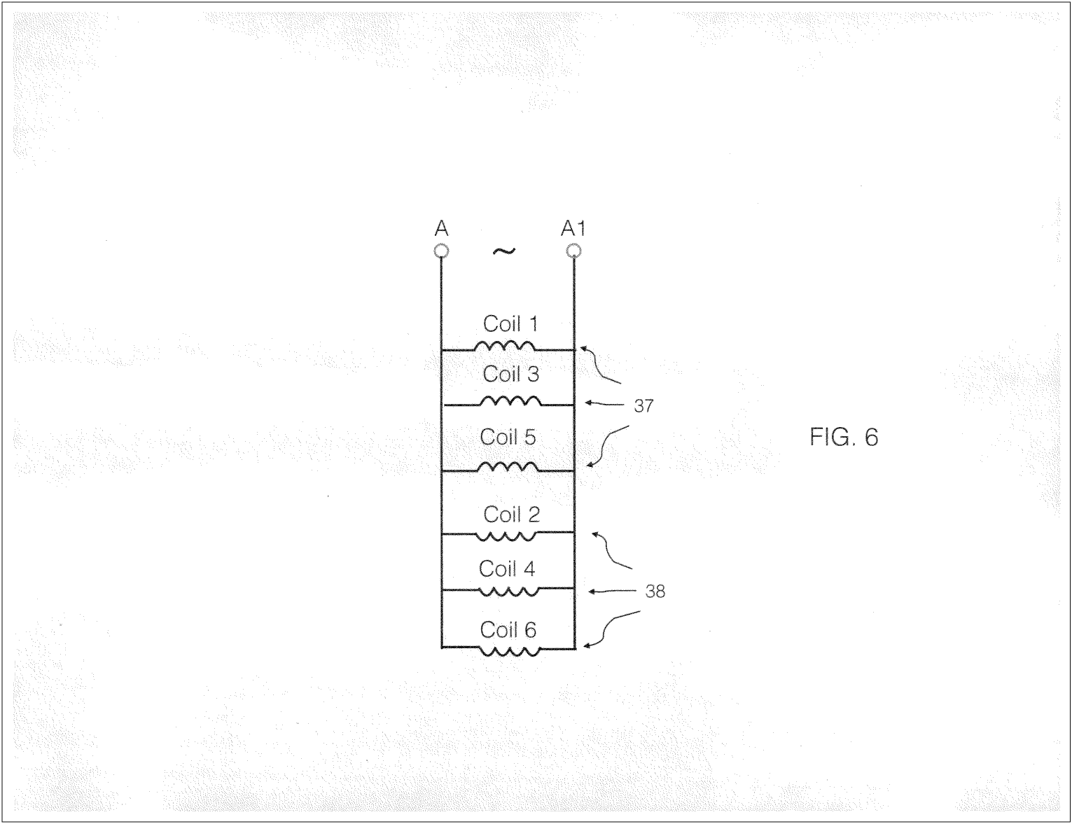

FIG. 6 is a schematics of the generator coils as showed in FIG. 5.

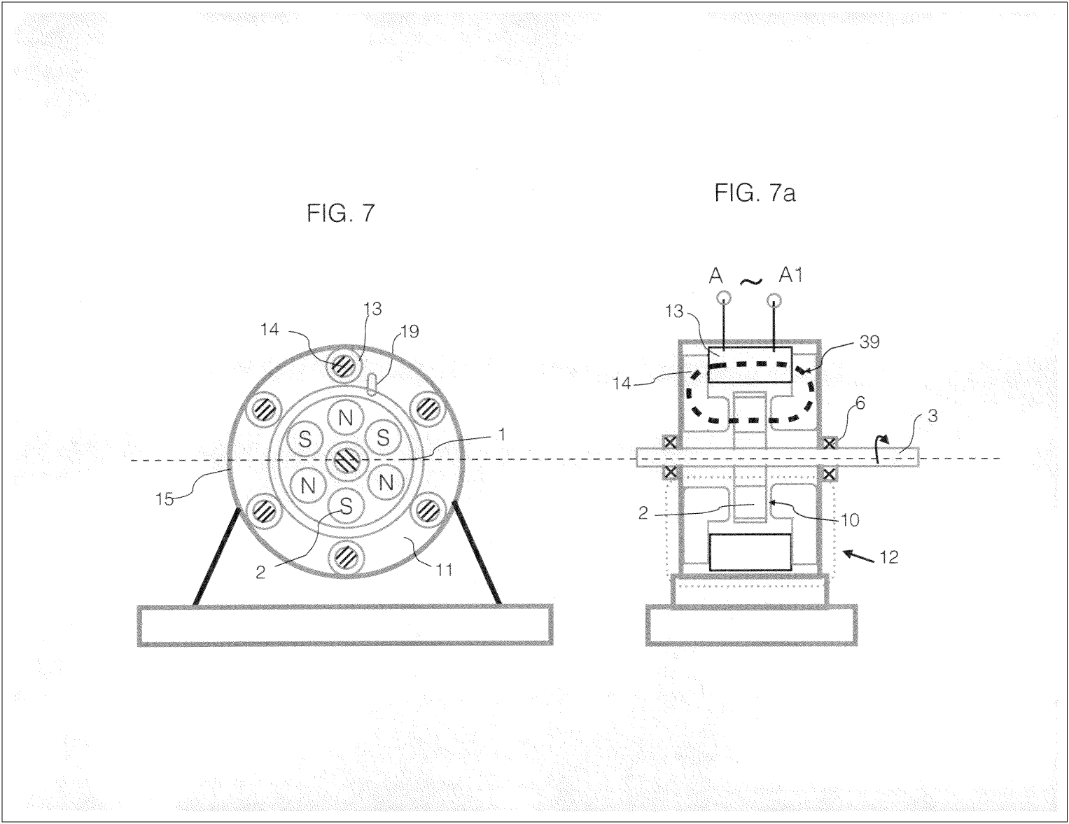

FIG. 7 is a front cross section view and FIG. 7a is a side section view, illustrating the working principle of a single-unit generator. When the rotor shaft 3 of a single-unit generator rotates, the permanent magnets 2 of the rotor 1 are just started away from C-shaped cores 14. At this time, the permanent magnets 2 cut the magnetic field of the armature C-type cores 14 and causes the magnetic flux 39 in the C-type core 14 to vary. According to Lenz’s law, if the maximum induced current and voltage are generated in the right-handed coil set 37, then the adjacent permanent magnets 2 with opposite polarities cut the magnetic field of the adjacent C-type core 14 of left-handed coil set 38, according to Lenz’s law also produces the same maximum induced current and voltage in the left-handed coil set 38 . Therefore, the induced current and voltage output by the two sets of the armature coils 12 are consistent. When the rotor continues to rotate, the permanent magnets 2 are gradually moved away from the C-shaped cores 14, and the induced current and voltage become smaller. When the permanent magnets 2 on the rotor 1 rotate to the middle of two adjacent C-shaped cores 14, the induced current and voltage are zero. When the rotor 1 continues to rotate, the following adjacent permanent magnets gradually approach the C-shaped core 14 . However, when the magnetic poles of the permanent magnet 2 are opposite in polarity, the induced current is generated in the opposite direction, so the induced voltage gradually becomes a negative value until it enters the coincident of the C-type iron core 14 . At this time, the maximum negative induced current and negative induced voltage are generated.

When the rotor 1 continues to rotate, until the permanent magnets 2 are coincident with the C-shaped cores 14, the induced current and voltage will gradually change from the minimum to the maximum. In this way, if the rotor 1 continues to rotate, it turns into the next power generation cycle. When the rotor shaft 3 rotates continuously and evenly, as shown in FIG. 6, the coil set ports A and A1 will generate single-phase sine wave alternating current. The frequency of the alternating current is equal to the rotor speed times the half number of the permanent magnets 2 in the rotor 1.

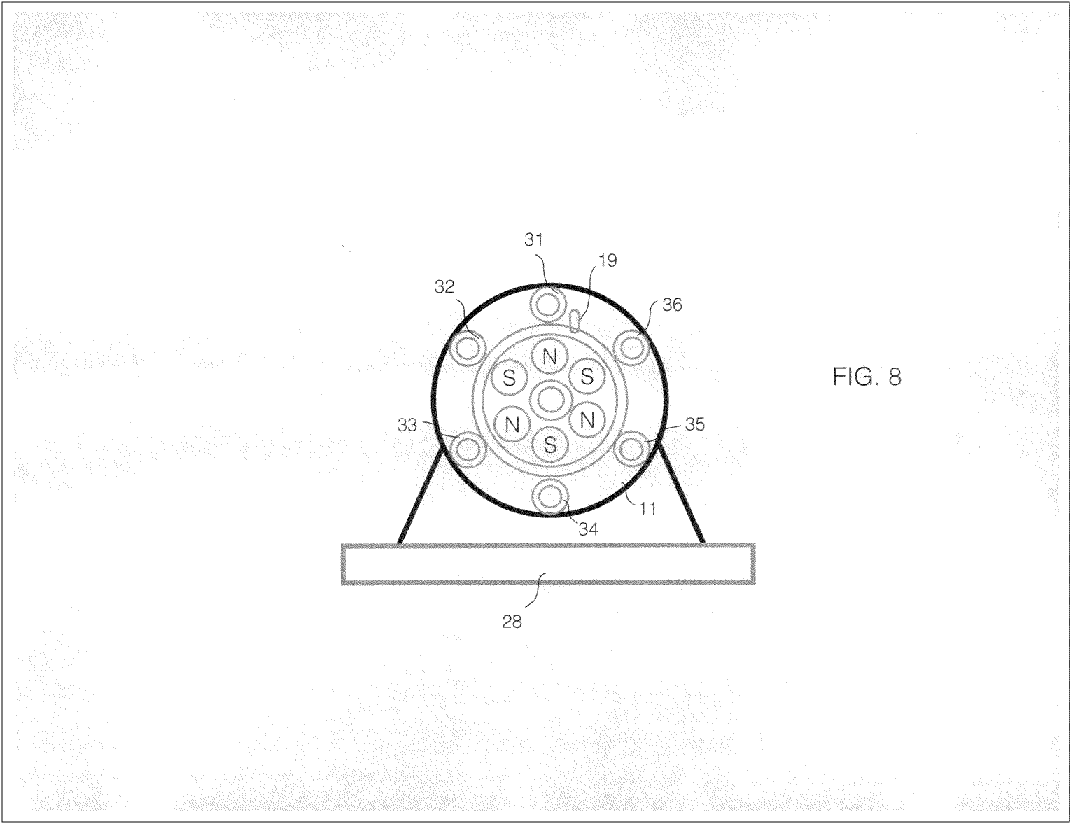

The second embodiment of the present invention is a single-unit motor 28 . FIG. 8 is a diagram of the front sectional view. It shows the positions of coil (1) 31, coil (2) 32, coil (3) 33, coil (4) 34, coil (5) 35 and coil (6) 36 in a stator 11.

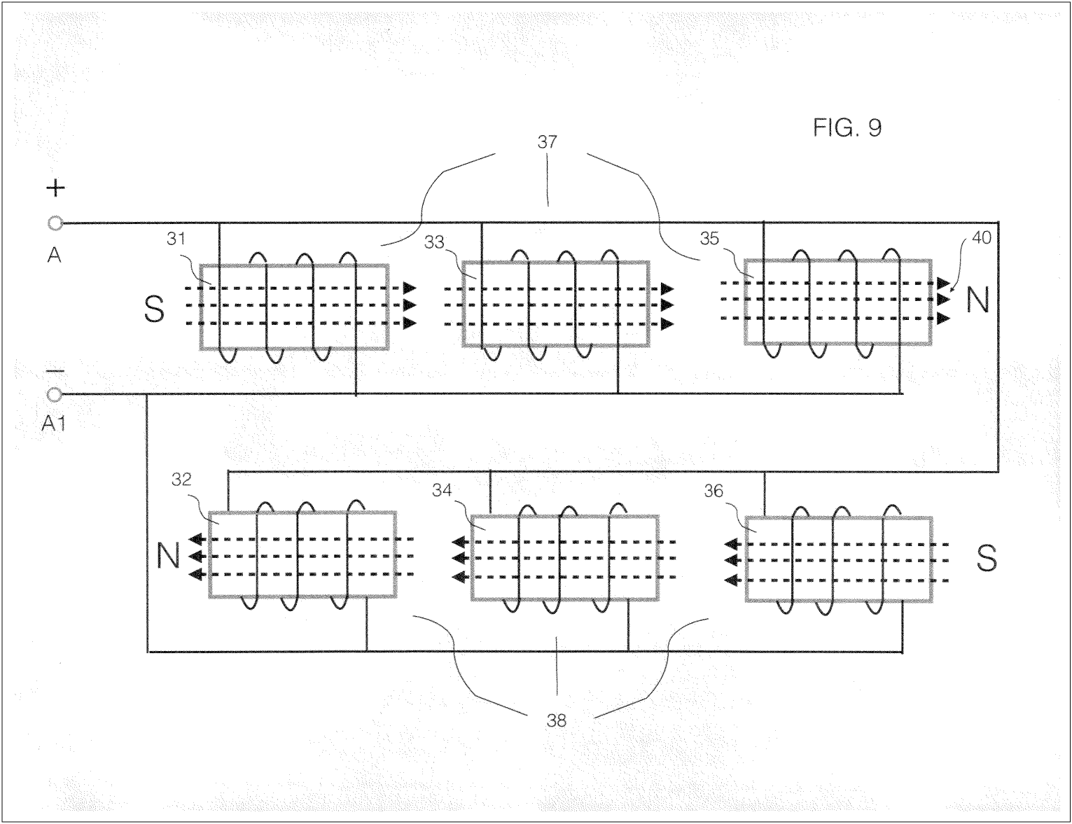

FIG. 9 shows a single-unit motor coil wiring diagram. Coil (1) 31, coil (3) 33, coil (5) 35 are right-handed coils 37. Coil (2) 32, coil (4) 34 and coil (6) 36 are left-handed coils 38. The above two sets of coils are connected in parallel, and the connection ports are A and A1. When the A port is connected to positive electricity and A1 is connected to negative electricity, the direction of magnetic field 40 in the right-handed coils 37 is to the right, and the direction of magnetic field 40 in the left-handed coils 38 is to the left according to Lenz’s law. That is, the direction of magnetic field of the right-handed coils 37 and the left-handed coils 38 are opposite.

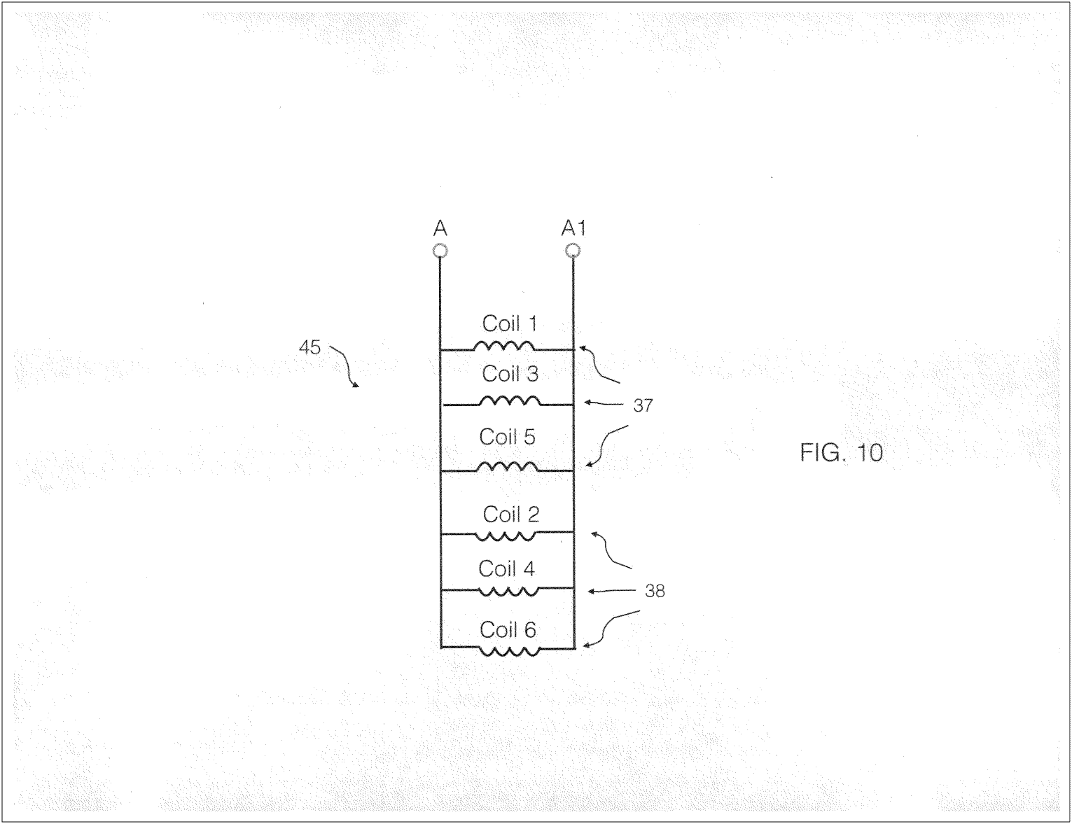

FIG. 10 is a schematics of the coil set 45 of a single-unit motor as FIG. 9 . FIG. 10 shows that coil (1) 31 , coil (3) 33 , coil (5) 35 are right-handed coils 37 . Coil (2) 32 , coil (4) 34 and coil (6) 36 are left-handed coils 38 . Connect the above coils in parallel, and the connection ports are A, A1.

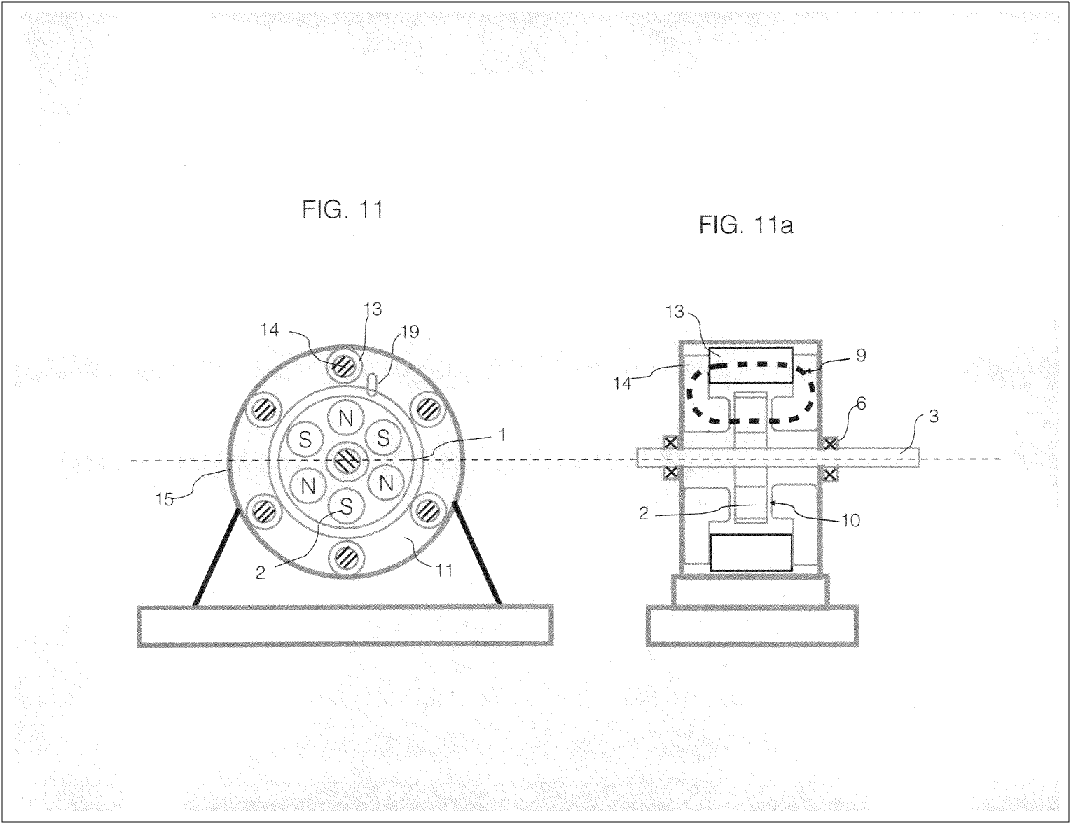

FIG. 11 is a front sectional view, and FIG. 11a is a side sectional view, illustrating the working principle of a single-unit motor. There is a small air gap 10 between a C-type iron core 14 and a permanent magnet 2. When a permanent magnet 2 on the rotor 1 intersects a C-type iron core 14, the magnetic flux of the C-type core 14 connects with the magnetic flux of the permanent magnet forming a closed magnetic flux loop 9. If the right-handed coils 37 generates a clockwise closed flux loop 9, the adjacent left-handed coil group 38 will generate a counterclockwise flux loop 9. Since the polarities of the adjacent permanent magnets 2 are also opposite, the above two sets of coils generate the same suction or repulsion force acting on the two poles of the corresponding permanent magnets 2. Each magnetic force vector on the corresponding permanent magnet 2 is also the same. If the motor is rotating, when the permanent magnet 2 of the rotor passes through the magnetic centerline of the C-type iron core 14, the current direction of a coil changes, so that the C-type core 14 generates an opposite magnetic field to the magnetic field of the permanent magnet 2, repelling and pushing the rotor to continue to rotate until the permanent magnet 2 is drawn into a magnetic field of the next C-shaped core 14 .

Similarly, when the permanent magnet 2 passes through the magnetic center line of the next C-shaped iron core 14, if the coil current changes direction at this time, the magnetic repulsion vector is generated again, so that the permanent magnet 2 on the rotor 1 is continuously pushed into the next of the next magnetic field.

When a single-unit motor is stationary, if the magnetic force centerlines of all the C-shaped iron cores 14 coincide with the magnetic force centerlines of the corresponding rotor permanent magnets 2 , each vector of the magnetic force of the C-shaped core 14 in the direction of rotor rotation is zero. Therefore, such single-unit motor cannot self-start. To start the single-unit motor, the rotor 1 must be deviated from the magnetic centerline of the C-shaped iron core 14 by external force, so as to obtain a vector magnetic thrust or suction acting in the direction of rotation of the rotor. Once the rotor 1 is started, it will pass through the magnetic centerlines 18 of the C-shaped iron cores 14 due to the inertia of the rotor 1. At this time, changing the current direction of the armature coils 14 will generate a vector magnetic force to make the rotor 1 continue to rotate in one direction. The reciprocating cycle keeps the motor running continuously.

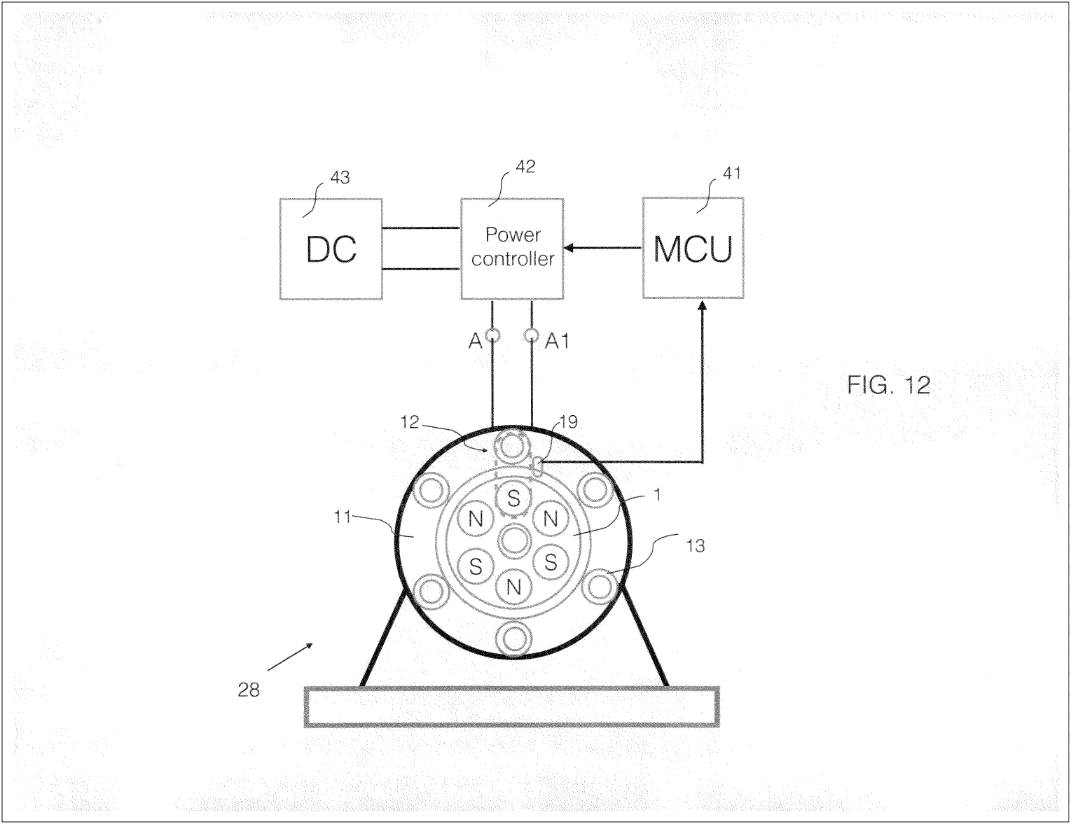

FIG. 12 is a diagram of a single-unit motor DC control mode. The armature coil set 45 of a motor 28 is connected as FIG. 10. The ports A and A1 are connected to a power controller 42. a micro-controller unit (MCU) 41 sends instructions to the power controller 42 according to a rotor position sensor 19 signal to determine the DC current direction through the armature coil set 45 to control turning, speed and stop of the motor 28. The single-unit motor can not be self-starting, but when an external starter is added to start, it can rotate steadily. The direction of rotation will continue once it was started.

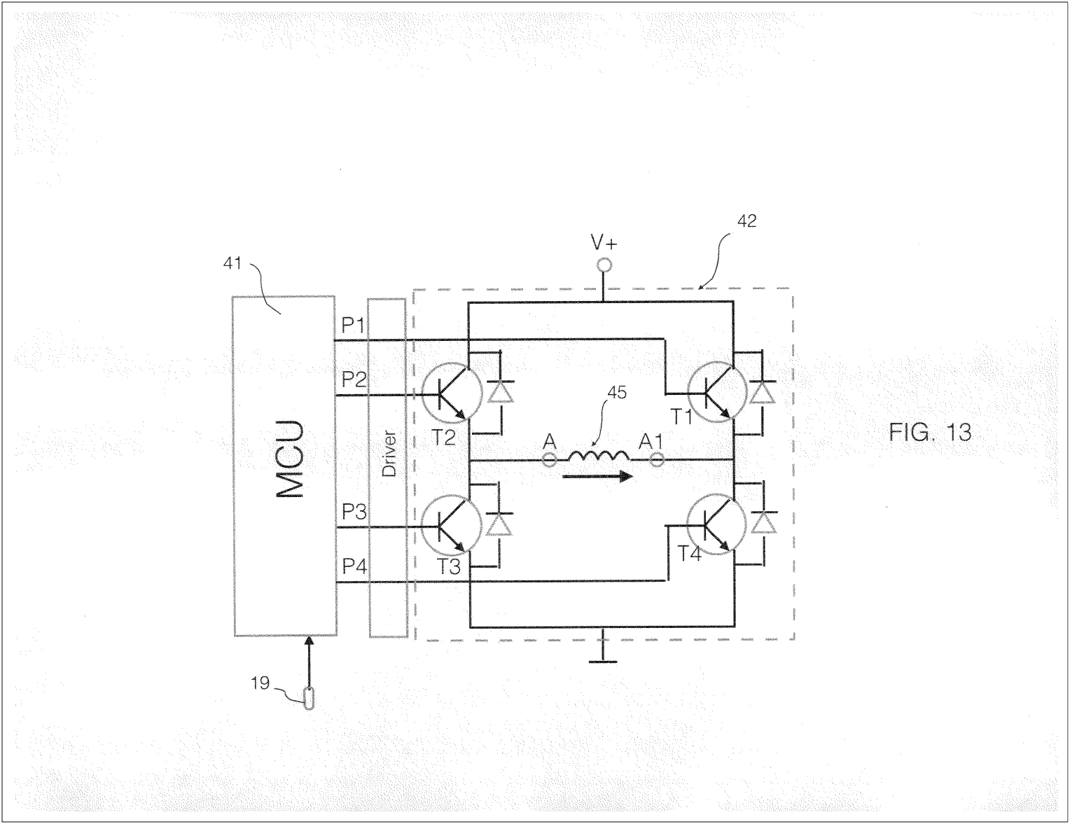

FIG. 13 is a schematics of a single-unit motor DC control mode. Four power transistors T1, T2, T3 and T4 are transistors as four switches to form a power controller 42. According to a rotor position sensor 19 signal, a micro-controller unit (MCU) 41 sends instructions to the power controller 42 , to determine the current direction of the armature coil set 45 . For example, according to the rotor position sensor 19 signal, the MCU 41 wants the current direction of the coil set 45 from A to A1, so through the P2 and P4 of the microcontroller 41 to turn on T2 and T4, and through P1 and P3 to turn off T1 and T3. If the MCU 41 wants the armature coil set 45 current direction is from A1 to A, then T2 and T4 are turned off through P2 and P4 of the microcontroller 41, and T1 and T3 are turned on through P1 and P3. To stop the motor, turn off all power transistors T1, T2, T3, T4.

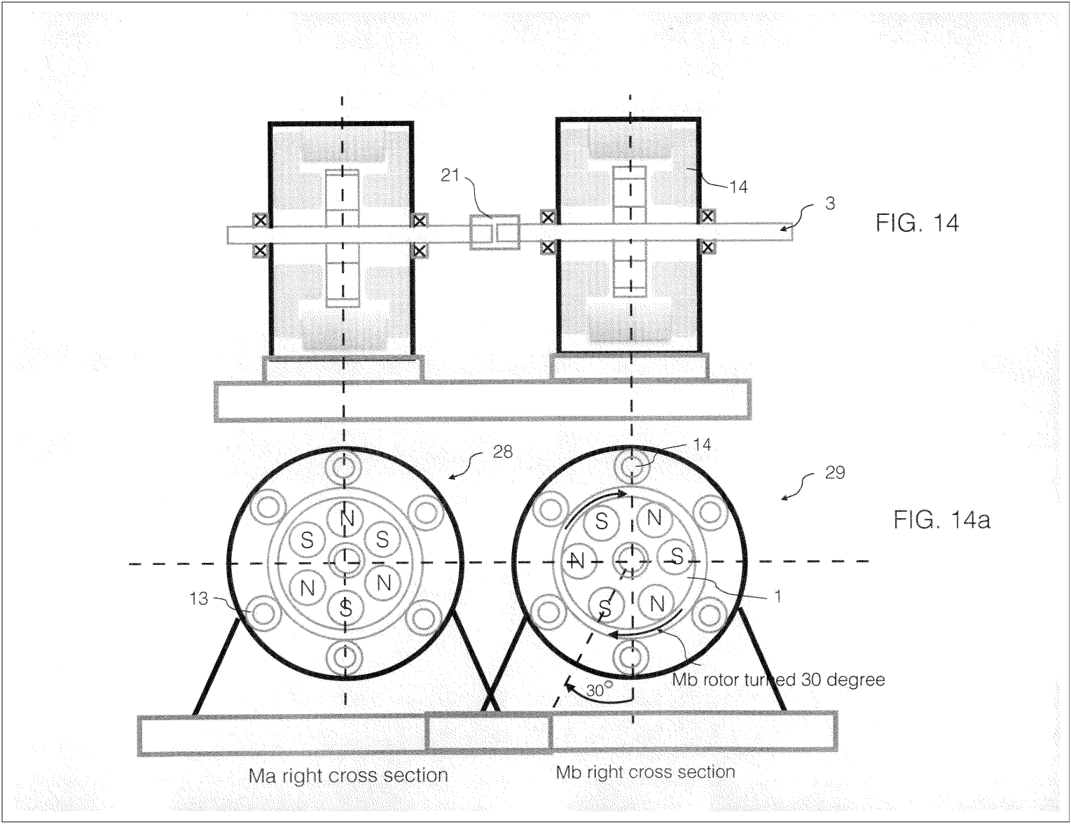

A third preferred embodiment of the present invention is a dual-unit motor. FIG. 14 is a side sectional view and FIG. 14a are front sectional views of Ma 28 and Mb 29. Since the single-unit motor does not have a start coil, the motor cannot be self- started, see FIG. 11. In order to achieve higher output power and start the motor automatically, the exemplary embodiment uses two identical single-unit motors to form a dual-unit motor. The connection method is that when the rotors 1 of the two motors Ma 28 and Mb 29 are in the same initial position, the rotor 1 of the motor Mb 29 is rotated by 1/2 centre angle of two adjacent permanent magnets, and then using a coupling 21 to connect the two motor shafts 3. (The center angle of adjacent permanent magnets = 360 degree / Number of permanent magnets). Thus, the magnetic centerline 8 of the permanent magnets on at least one rotor does not coincide with the magnetic centerline 18 of the C-shaped core 14. So, one motor generates a tangential force on the rotor to start the dual-unit motor. All armature coils 13 are both starting windings and running windings, therefore dual-unit motor has higher torque, power and efficiency.

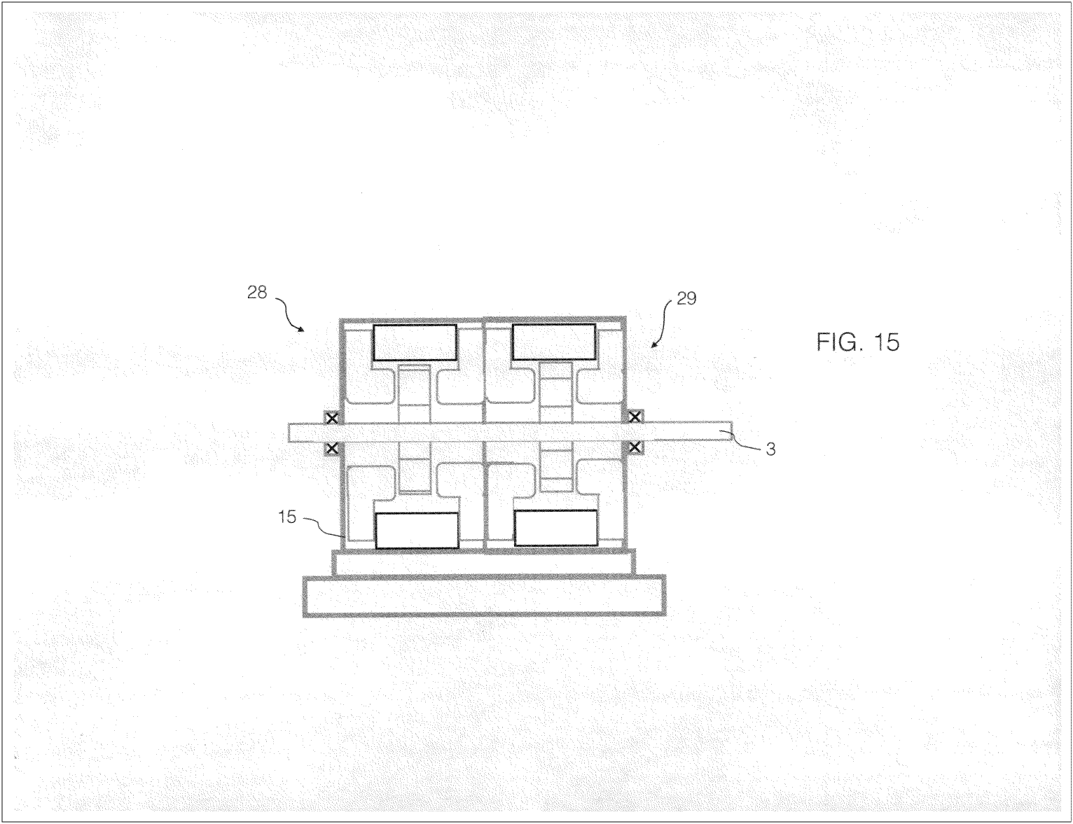

FIG. 15 shows an present embodiment of a dual-unit motor. The two motors Ma 28 and Mb 29 are combined in one casing 15 . The two rotors 1 are mounted on one rotor shaft 3 instead of using coupling. Refer to FIG. 14 for the installation method of rotor 1.

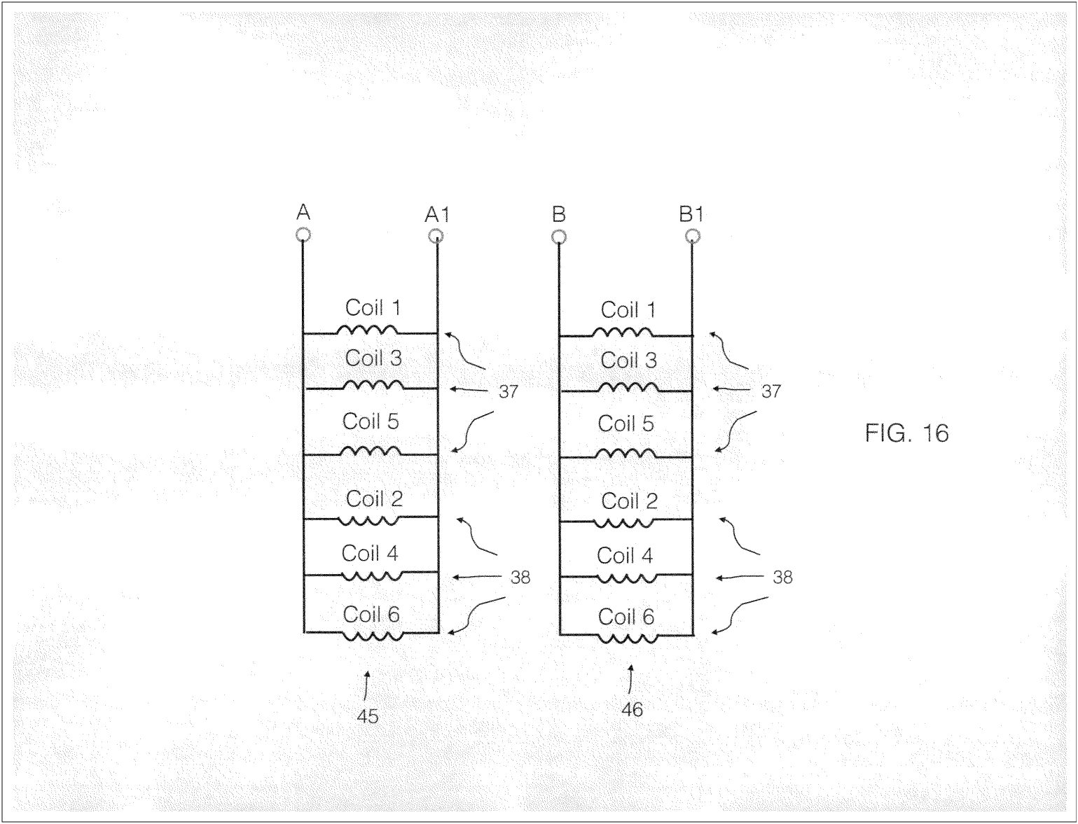

FIG. 16 is a wiring diagram of a Ma coil set 45 and a Mb coil set 46. The wiring ports of the Ma coil set 45 are A and A1. The wiring ports of the Mb coil set 46 are B and B1. The armature coil (1), coil (3) and coil (5) are right-handed coils 37. the armature coil (2), coil (4) and coil (6) are left-handed coils 38 .

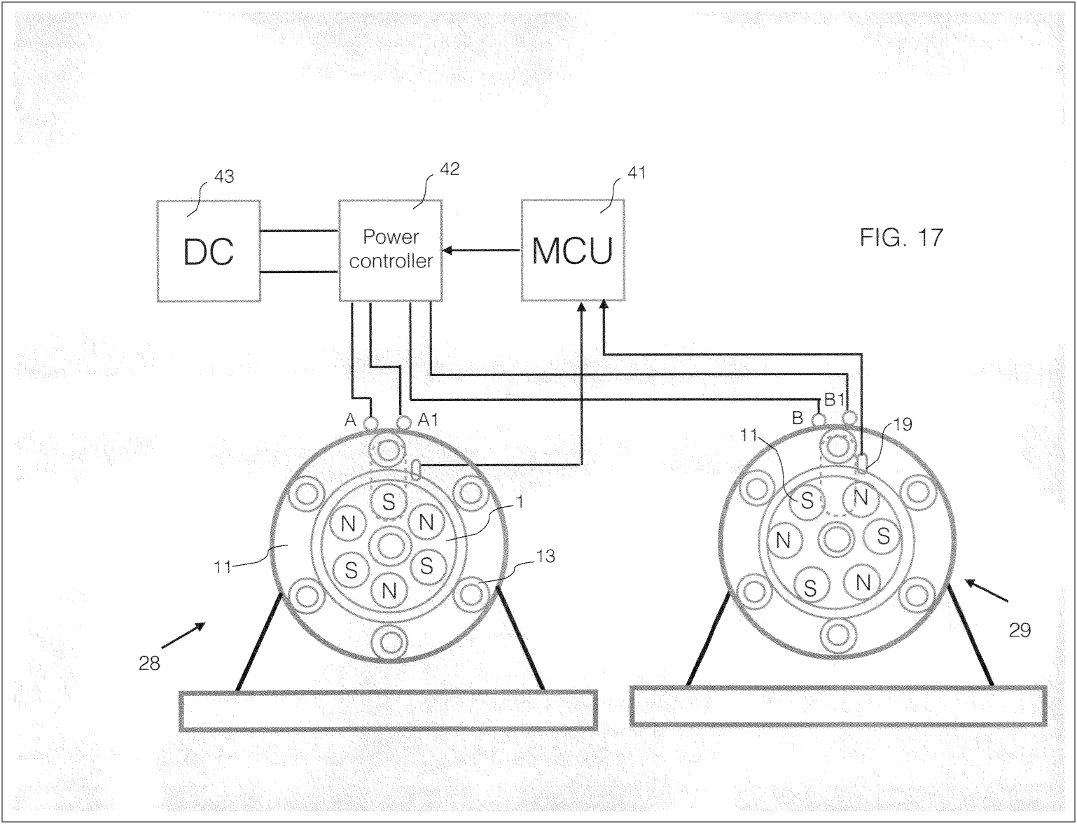

FIG. 17 is a wiring diagram of DC control mode for dual-unit motor. Refer to FIG. 16 for the wiring of Ma armature coil set 45 and Motor Mb armature coil set 46. The connection ports A and A1, and B and B1 are connected to a power controller 42. An MCU 41 sends instructions to the power controller 42 based on the two rotor position sensors 19 information to determine the current direction of the two armature coil sets in order to control the motor start/stop, turning direction and speed.

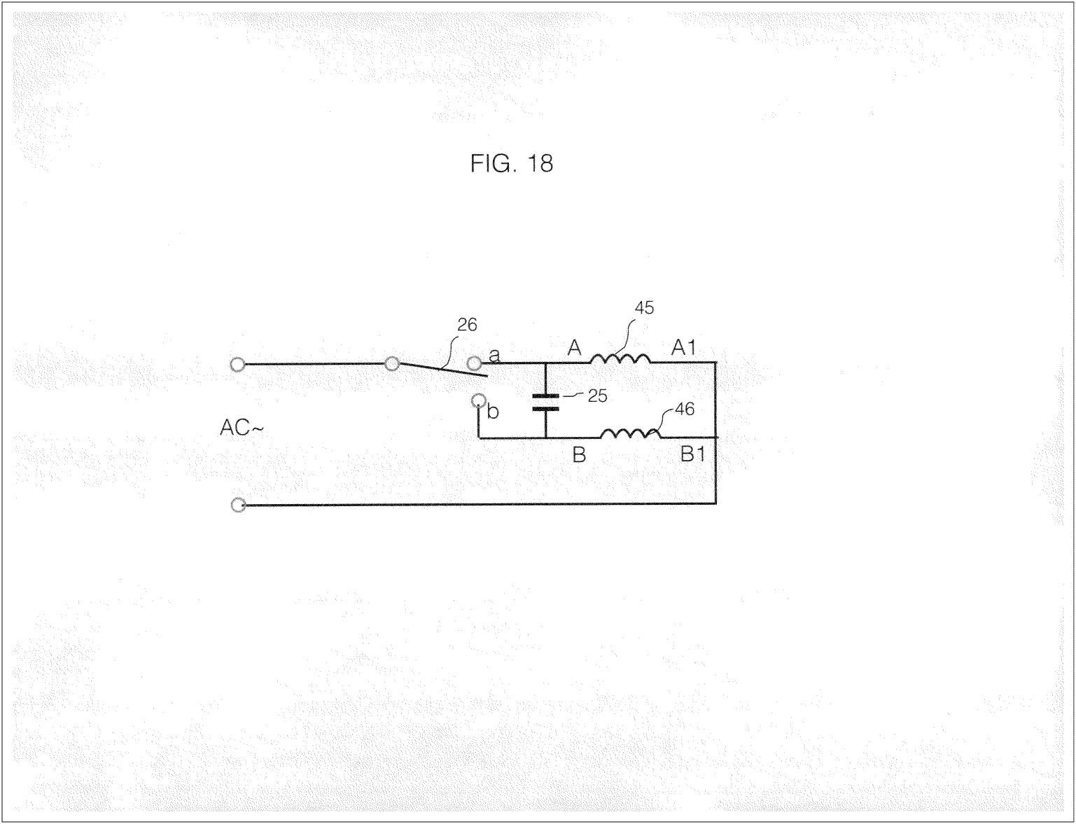

FIG. 18 is a schematic diagram of AC control mode for a dual-unit motor. A capacitor 25 is connected between the port A and the port B. The purpose of the capacitor is to create a poly-phase power supply from a single-phase power supply. With a poly-phase supply, the motor is able to set the rotation direction and provide starting torque for the motor. If the motor rotates clockwise when a switch 26 switches to position a, the motor will rotate counterclockwise when the switch 26 switches to position b.

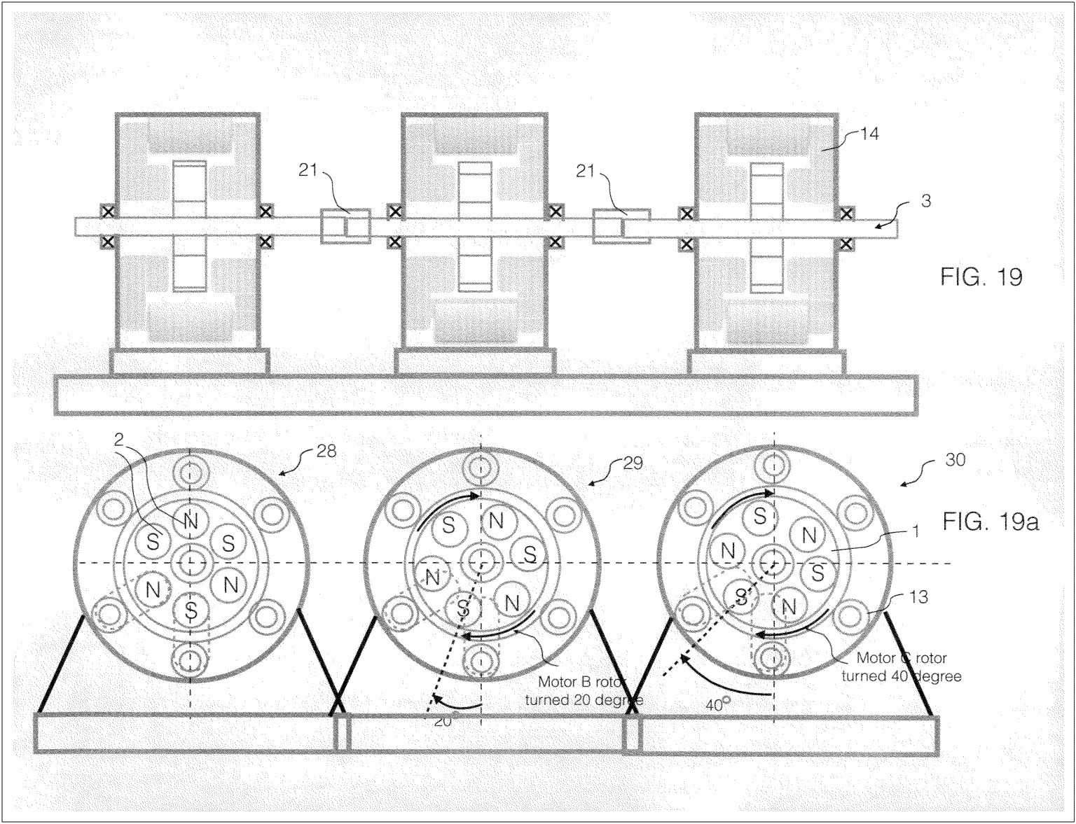

A fourth embodiment of the present invention is a Triple-unit Closed-loop flux motor. FIG. 19 is a side section. FIG. 19a are front section views. Also, in order to obtain greater output power, 3 single-unit motors Ma 28, Mb 29 and Mc 30 are connected to the three shafts 3 by two couplings 21 . The connection method is when the rotors 1 of the three motors Ma 28, Mb 29 and Mc 30 are in the same initial position, rotate the rotor 1 of the motor Mb 29 clockwise by 1/3 center angle of two adjacent permanent magnets 2, and then use a coupling 21 connects the two motor shafts 3 of Ma 28 and Mb 29. Then the rotor 1 of Mc 30 is rotated clockwise by 2/3 center angle of adjacent permanent magnets 2, and another coupling 21 connects the two motor shafts 3 of Mb 29 and Mc 30 . (The center angle of adjacent permanent magnets = 360 degree / Number of permanent magnets). In this way, the magnetic pole NS lines 8 of the permanent magnets 2 on at least two rotors do not coincide with the magnetic core lines 18 of the C-shaped core 14, thereby generating a tangential force on the rotors 1 to start the triple-unit motor. All armature coils 13 are both starting windings and running windings, so the triple-unit motor has higher torque, power and efficiency.

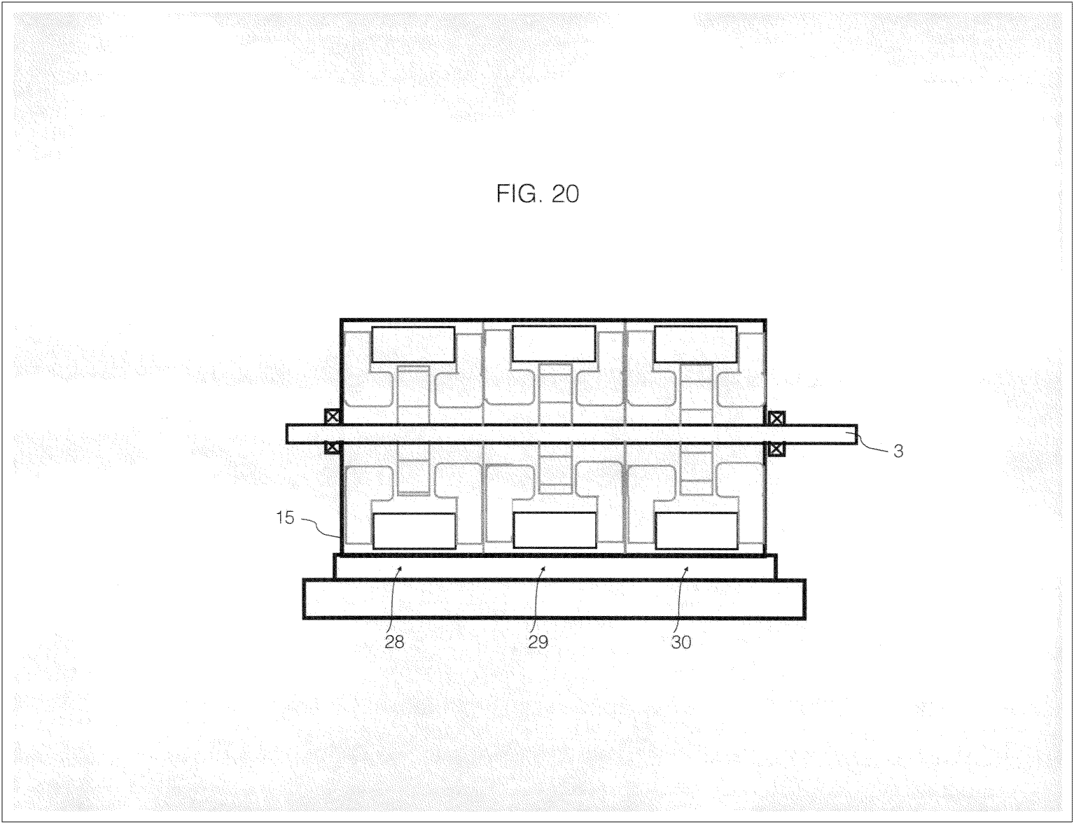

FIG. 20 shows an present embodiment of a triple-unit motor. The three single-unit motors Ma 28, Mb 29 and Me 30 are combined in one casing 15 . The three rotors 1 are mounted on one rotor shaft 3 instead of using coupling. Refer to FIG. 14 for the installation method of rotor 1.

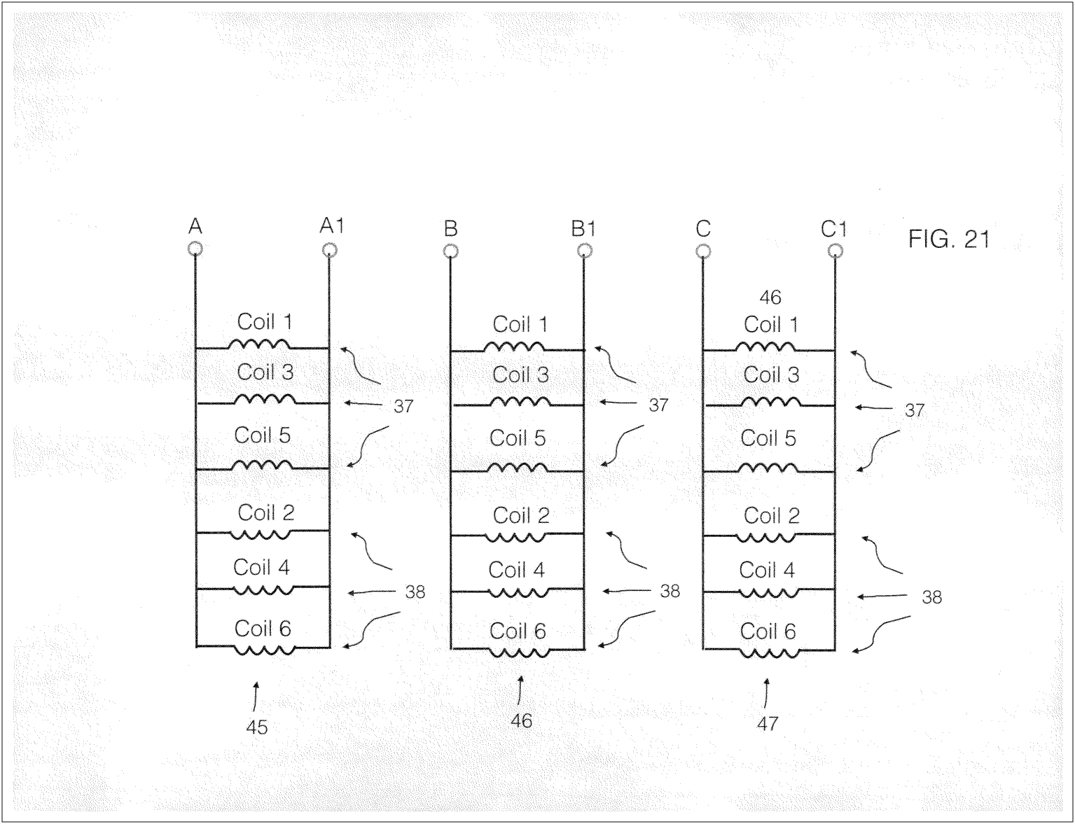

FIG. 21 is a wiring diagram of a Ma coil set 45, Mb coil set 46 and Mc coil set 47. The wiring ports of the Ma coil set 45 are A and A1. The wiring ports of the Mb coil set 46 are B and B1. The wiring ports of the Mc coil set 47 are C and C1. The armature coils (1), coils (3) and coils (5) are the right-handed coil 37 . The armature coils (2), coils (4) and coils (6) are left-handed coils 38 .

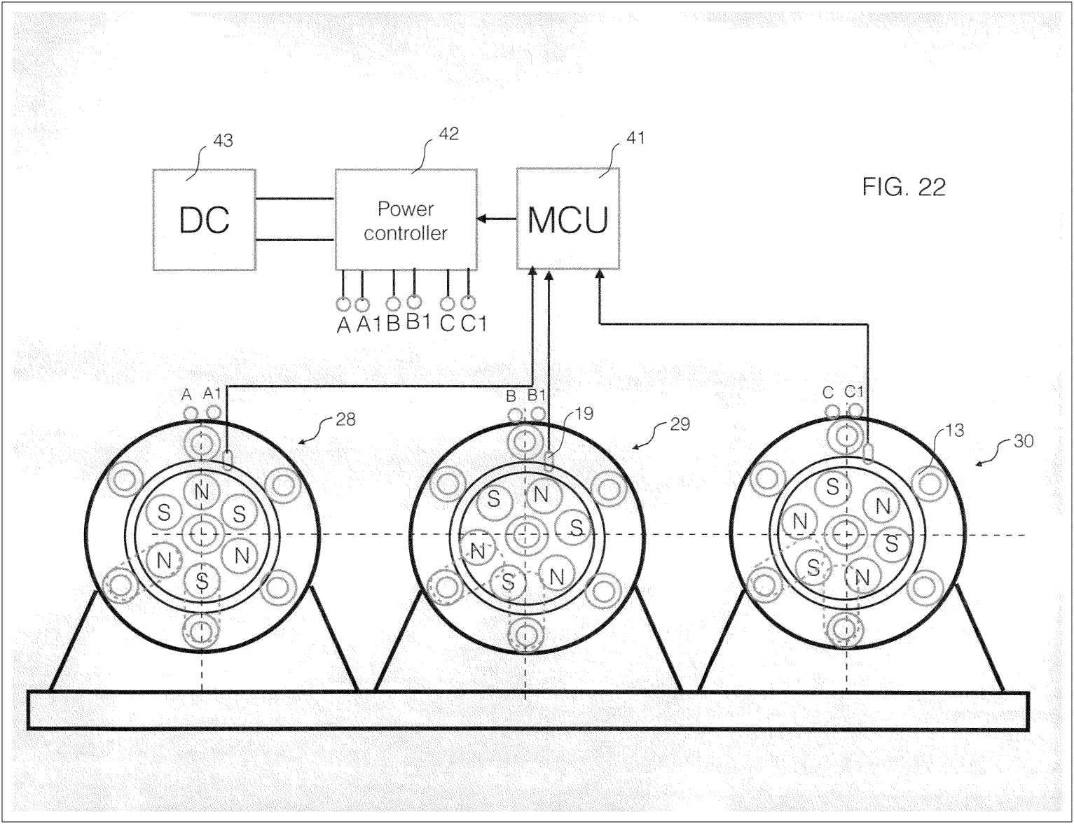

FIG. 22 is a wiring diagram of DC control mode for a triple-unit motor. Refer to FIG. 21 for the wiring of Ma armature coil set 45 , Mb armature coil set 46 and Mc armature coil set 47. The connection ports A and A1, B and B1, and C and C1 are connected to a power controller 42. An MCU 41 sends instructions to the power controller 42 based on the three rotor position sensors 19 information to determine the current direction of the three armature coil sets in order to control the motor start/stop, turning direction and speed.

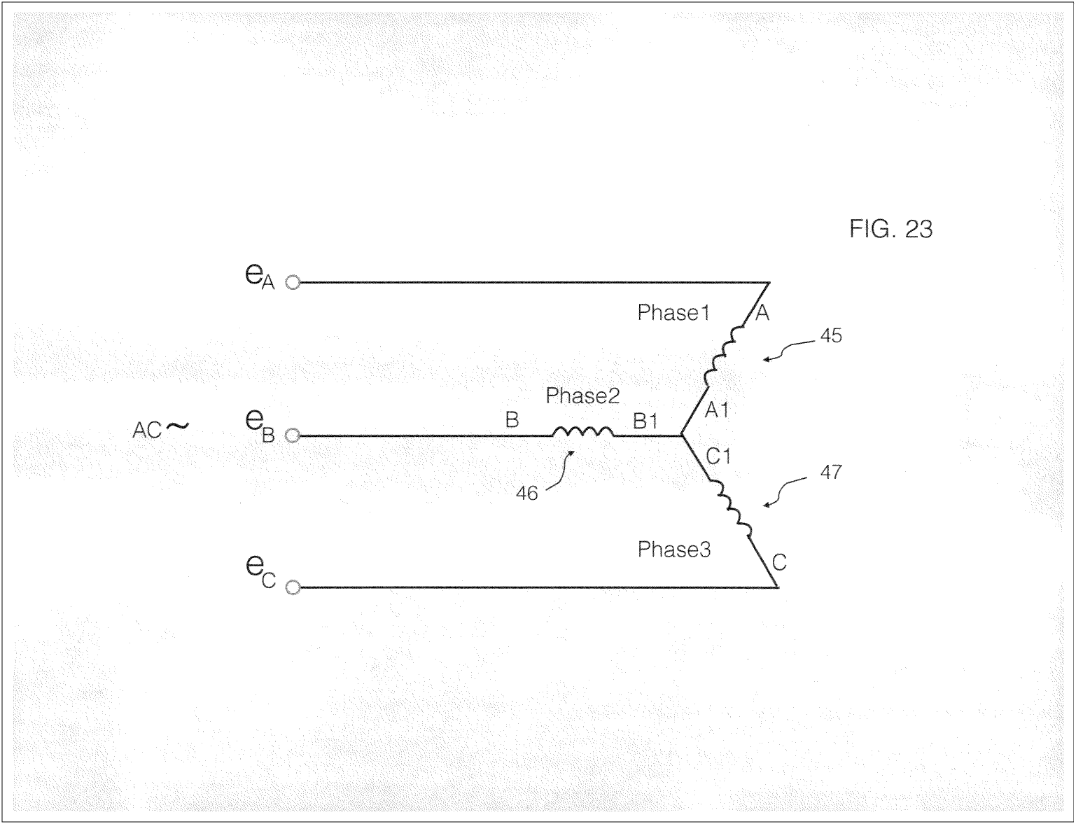

FIG. 23 is a schematics of a Star connection for a three-phase AC triple-unit motor. According to the requirements of FIG. 21 to connect the Ma armature coil set 45, Mb armature coil set 46 and Mc armature coil set 47, then follow the FIG. 23 schametics of the Star connection.

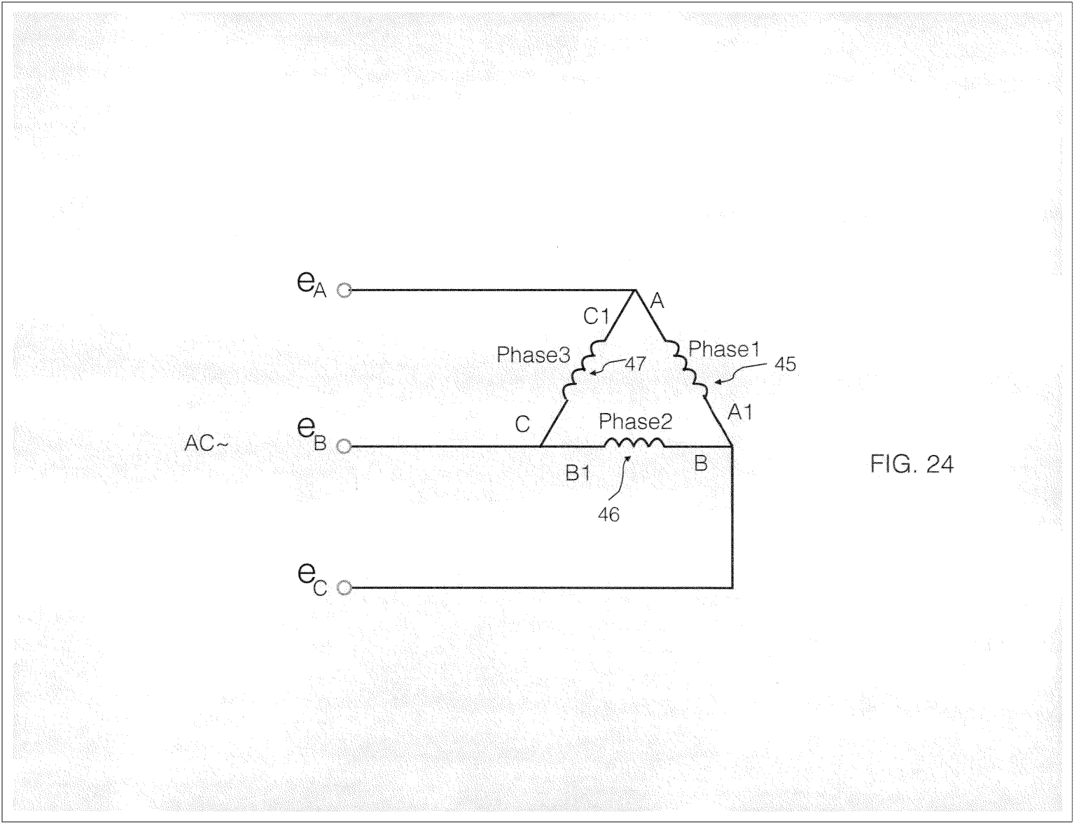

FIG. 24 is a schematics of a Delta connection for a three-phase AC triple-unit motor. According to the requirements of FIG. 21 to connect the Ma armature coil set 45, Mb armature coil set 46 and Mc armature coil set 47, then follow the FIG. 24 schematics of the Delta connection.

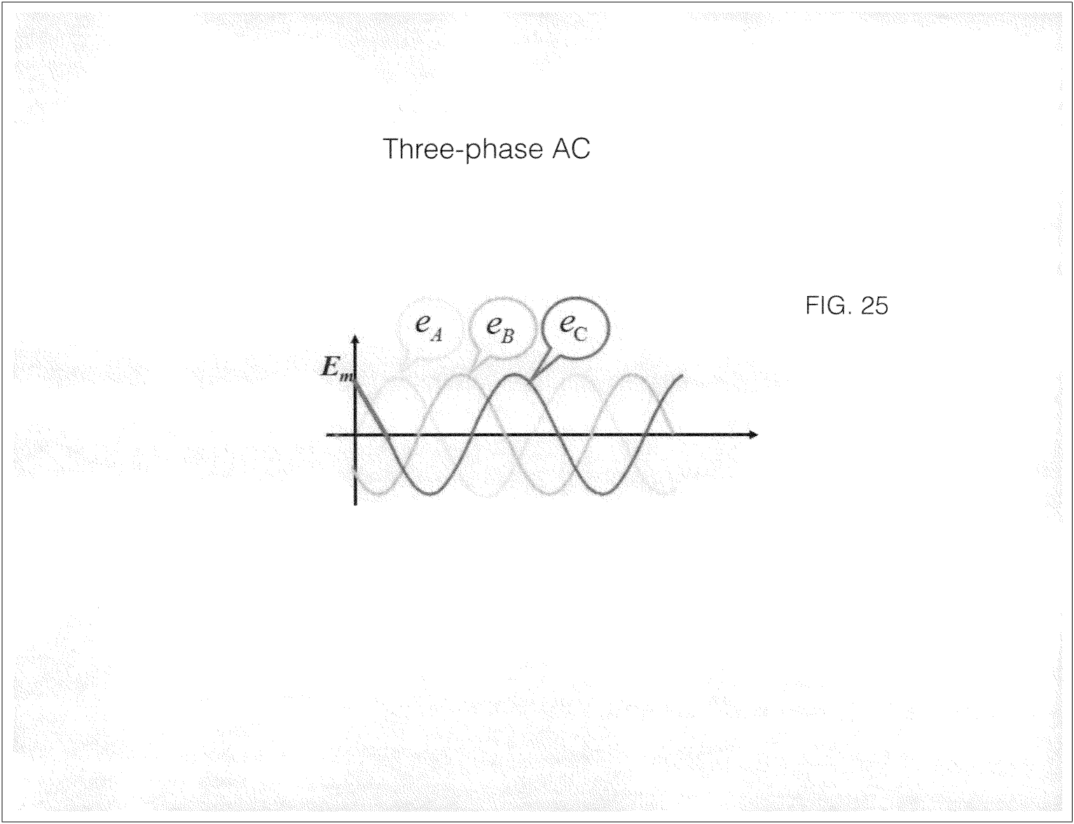

FIG. 25 is a standard three-phase AC waveform diagram. According to FIG. 23 or FIG. 24, when the standard three-phase AC power is input to the triple-unit motor, the motor will run in a stable speed and torque .

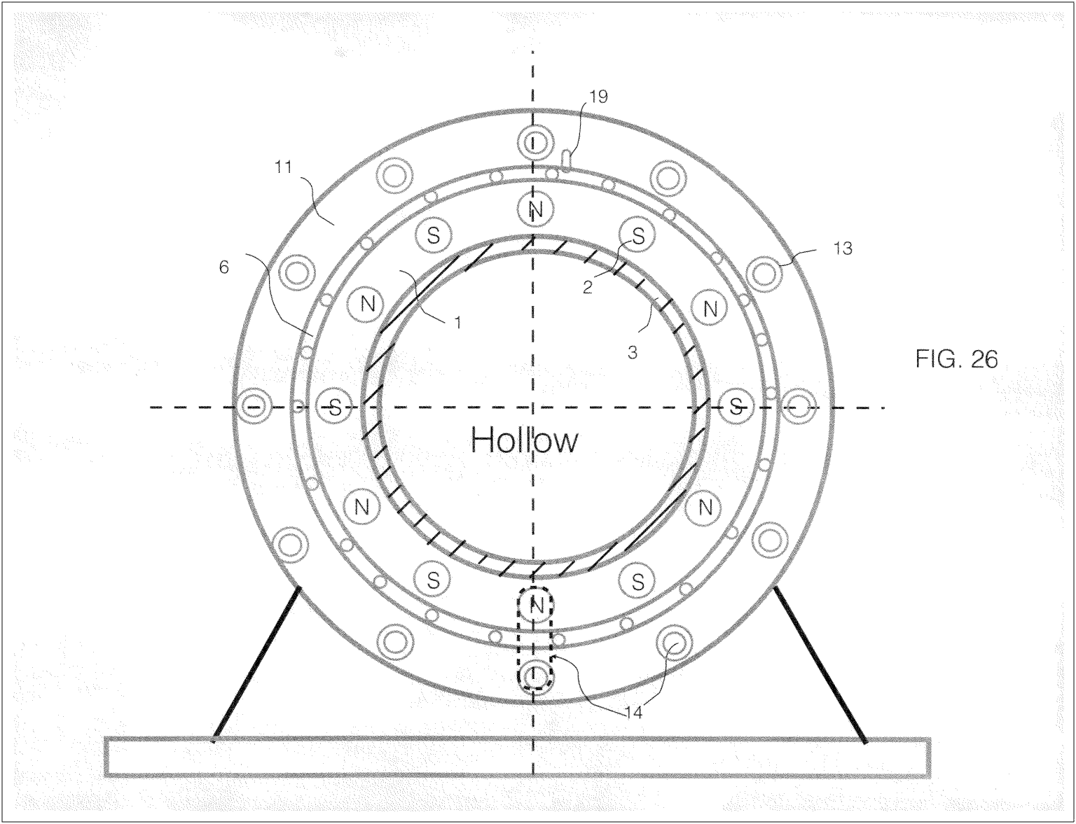

FIG. 26 is a front section view of a shaftless motor. An axial closed-loop flux electric motor or generator can be retrofitted into a shaftless motor or shaftless generator, by increasing the diameter of the rotor disk 1 and a hollow shaft 3. The rotor disk 7 is mounted on the inner ring of a bearing 6, which is mounted on the stator 11 within the grooves of C-shaped cores 14.

Thus it can be seen that the objects of the invention have been satisfied by the structure presented herein above. Accordingly, for an appreciation of the true scope and breath of the invention reference should be made to the claims.

List numbers of components, parts and units:
1. Rotor
2.Permanent magnet
3. Shaft
4. Hole
6. Bearing
7. Rotor disc
8. Magnetic pole NS line
9. Closed-loop flux
10. Air gap
11. Stator
12. Armature
13. Coil
14. C-shaped (iron) core
15. Motor casing
18. Magnetic flux centerline
19. Rotor position sensor
21. Coupling
25. Capacitor
26. Direction Switch.
28. Ma, motor A
29. Mb, motor B
30. Mc, motor C
31. Coil (1)
32. Coil (2)
33. Coil (3)
34. Coil (4)
35. Coil (5)
36. Coil (6)
37. Right-handed coil
38. Left -handed coil
39. Magnetic flux
40. Magnetic field
41. MCU
42. Power controller
43. DC power supply
45. Ma armature coil set
46. Mb armature coil set
47. Mc armature coil set

### Patent Citations

US6445105B1 1999-04-06 Gerald Burt Kliman Axial flux machine and method of fabrication

US5619087A 2002-09-03 Kazuto Sakai Axial-gap rotary-electric machine

US20080001488A1 2004-08-25 2008-01-03 Axco-Motors Oy Axial Flux Induction Electric Machine

US9577502B2 2017-02-21 Transverse flux permanent magnet rotatory device

WO2001011755A1 * 1999-08-09 2001-02-15 Perm Motor Gmbh Electric axial flow machine

US6198194B11999-09-17 2001-03-06 Trw Inc. Segmented rotor for an electric machine

US20010008356A1 * 2000-01-19 2001-07-19 Wilkin Geoffrey A Rotor disc

US20020171324A1 * 1996-12-11 2002-11-21 Smith Stephen H. Axial field electric machine

US20030011274A1 * 2001-07-13 2003-01-16 Moteurs Leroy-SomerDiscoid machine

US20030146672A1 * 1998-03-25 2003-08-07 Shinji Fukushima Method of manufacturing stators for brushless motors

US6605883B2 * 2001-04-20 2003-08-12 Japan Servo Co., Ltd.

1. An axial closed-loop flux electric motor or generator including:
(1) a single-unit motor comprising:
(a) a rotor having a shaft, a flat cylindrical disk fixedly attached to the shaft, permanent magnets, and bearings mounted to the shaft;
(b) a stator having at least one armature which consists of a C-shaped core and a coil wound on the C-shaped core, a motor casing and other structural parts that fix these parts;
(c) and an electronic control system having MCU, power supply, power controller to control the current direction of the coils, a rotor position sensor or a shaft angle sensor which can be Hall effect elements, optical sensor, photoelectric sensor or any device which can sense the rotor disk position or the rotation angle of the rotor shaft;
(2) a dual-unit motor which consists of two single-unit motors, combined in one casing and the two rotor discs fixedly attached to one rotor shaft at different rotation angles;
(3) a triple-unit motor which consists of three single-unit motors, combined in one casing and the three rotor discs fixedly attached to one rotor shaft at different rotation angles; and multi-unit motors which consist of more than three single-unit motors, combined in one casing and all rotor discs fixedly attached to one rotor shaft at different rotation angles.

2. The axial closed-loop flux electric motor or generator of claim 1 , wherein said disk is a flat cylindrical disk made of non-magnetic material, on which having even-numbered through holes at equal distances from the centre of said disc, and at equal central angle of said disk.

3. The axial closed-loop flux electric motor or generator of claim 2, wherein the permanent magnets are fixed or embedded in said holes.

4. The axial closed-loop flux electric motor or generator of claim 3 , wherein the pole NS lines of said permanent magnets in said holes are all parallel to said shaft axis, and the poles of adjacent said permanent magnets are opposite.

5. The axial closed-loop flux electric motor or generator of claim 1 , wherein said armature(s) straddles the edge of said rotor disc without touching it, and maintain a narrow air gap between said C-shaped core(s) and the surface of poles of said permanent magnets of said rotor.

6. The axial closed-loop flux electric motor or generator of claim 5, wherein said permanent magnets on said rotor can freely pass through the grooves of all said C-shaped cores on said stator.

7. The axial closed-loop flux electric motor or generator of claim 1 , wherein said armature coils on said stator are connected in parallel, and adjacent armature coils wound in opposite directions, called left-handed coil and right-handed coil.

8. The axial closed-loop flux electric motor or generator of claim 1, wherein said single-unit motor also is a single-phase AC generator, and said triple-unit motor also is a three-phase AC generator.

9. An axial closed-loop flux electric motor or generator can be retrofitted into a shaftless motor or shaftless generator, by increasing the diameter of said rotor disk(s) and a hollow shaft.

10. The axial closed-loop flux electric motor or generator of claim 9, wherein said rotor disk(s) and two bearings are fixedly attached to said hollow shaft.

11. The axial closed-loop flux electric motor or generator of claim 9, wherein said rotor disk also can be fixedly attached to the inner ring of a bearing which is mounted on said stator and within the grooves of all said C-shaped cores.
